(19) United States
(12) Patent Application Publication
(10) Pub. No.: US 2020/0041076 A1
(43) Pub. Date: Feb. 6, 2020

(54) A RETROFIT LIGHT EMITTING DIODE, LED, LIGHTING DEVICE FOR CONNECTION TO AN ELECTRONIC BALLASE

(71) Applicant: SIGNIFY HOLDING B.V., EINDHOVEN (NL)

(72) Inventors: HENRICUS THEODORUS VAN DER ZANDEN, SINT-OEDENRODE (NL); BERND ACKERMANN, AACHEN (DE); THEODORUS JOHANNES PETRUS VAN DEN BIGGELAAR, VELDHOVEN (NL); HAIMIN TAO, EINDHOVEN (NL); PIETER JOHANNES STOBBELAAR, EINDHOVEN (NL)

(21) Appl. No.: 16/485,191

(22) PCT Filed: Feb. 14, 2018
(86) PCT No.: PCT/EP2018/053686

§ 371 Date: Aug. 12, 2019

(30) Foreign Application Priority Data
Feb. 27, 2017 (EP) 17158032.7

(51) Int. Cl. F21K 9/278; H05B 37/02; H05B 33/08

(52) U.S. Cl. CPC F21K 9/278; H05B 33/0809; H05B 37/0272

(57) ABSTRACT

A retrofit Light Emitting Diode, LED, lighting device for connection to an electronic ballast is presented. Wherein the LED lighting device comprises a steady state mode during which it emits light and a standby mode during which it is not emitting light. The retrofit LED lighting device comprises an LED array for emitting light during said steady state mode; an alternating current, AC, LED driver arranged for receiving an AC supply voltage, from said electronic ballast during said steady state mode and for driving said LED array based on said received AC supply voltage. It also comprises of a filament circuit arranged for receiving said AC supply voltage from said electronic ballast and for supporting a filament current circulating back to said electronic ballast for indicating a presence said lighting device to said electronic ballast, and a lamp current to said AC LED driver for driving said LED array for emitting said light during said steady state mode. Additionally, the retrofit LED lighting device also comprise of a lamp removal simulation circuit arranged for simulating an absence of said LED lighting device to said electronic ballast by interrupting at least one of said filament current and said lamp current, during said standby mode. A corresponding method and system of retrofitting LEDs are also presented.

### FIELD OF THE INVENTION

The present invention generally relates to the field of lighting and, more specifically, to a retrofit Light Emitting Diode, LED, lighting device. The present invention further relates to a lighting system comprising an electronic ballast as well as a LED lighting device, and to a method of operating a retrofit LED lighting device.

### BACKGROUND OF THE INVENTION

Lighting devices have been developed that make use of Light Emitting Diodes, LEDs, for a variety of lighting applications. Owing to their long lifetime and high energy efficiency, LED lamps are nowadays also designed for replacing traditional fluorescent lamps, i.e. for retrofit applications. For such an application, a retrofit LED lighting device is typically adapted to fit into the socket of the respective lamp fixture to be retrofitted. Moreover, since the maintenance of a lighting device is typically conducted by a user, the retrofit LED lighting device should ideally be readily operational with any type of suitable fixture without the need for re-wiring the fixture.

A specific type of a retrofit LED lighting device, i.e. a retrofit LED tube, is, for example, disclosed in US 2015/0198290. Here, an LED lighting device arrangement is disclosed for replacing a fluorescent lighting device in a luminaire having a ballast for supplying power to the lighting device. The LED lighting device arrangement comprises a plurality of LEDs arranged in a plurality of groups, wherein the groups of LEDs are connectable in a plurality of circuit configurations, including at least a first circuit configuration, and a second circuit configuration having a different circuit arrangement of the groups of LEDs in which at least a portion of the groups of LEDs are connected into the circuit differently than in the first circuit configuration.

Typically, ballasts are used in conventional fluorescent lamps to limit the current through the lamp, which could otherwise rise to destructive levels due to the negative differential resistance artefact in the tube's voltage-current characteristic.

One of the drawbacks in these known retrofit LED lighting devices is that, still too much unnecessary power is consumed. This is especially the case in a so-called standby mode. Typically, in a standby mode, electronics present in the retrofit LED lighting device are still powered by the ballast, but the LED array present in the lighting device does not emit any light. As such, the electronics ensure that the lighting device is, for example, receptive for receiving wireless commands, or anything alike, such that the lighting device can be switched back to a steady state mode. A steady state mode is a mode in which the retrofit LED lighting device is actually emitting light, i.e. the retrofit LED lighting device is turned on.

WO 2016/022612 discloses a solid state lighting system including a number of light sources with multiple light colors that can be used to replace fluorescent lamps.

### SUMMARY OF THE INVENTION

It would be advantageous to achieve a retrofit Light Emitting Diode, LED, lighting device that is designed in such a way that the total amount of power consumed in a standby mode is reduced. It would also be desirable to achieve a method of operating the retrofit LED lighting device such that the total amount of power in the standby mode is reduced.

To better address one or more of these concerns, in a first aspect of the invention, a retrofit Light Emitting Diode, LED, lighting device for connection to an electronic ballast is provided. The LED lighting device comprises a steady state mode during which it emits light and a standby mode during which it is not emitting light, said retrofit LED lighting device comprising:
an LED array for emitting light during said steady state mode;
an alternating current, AC, LED driver arranged for receiving an AC supply voltage, from said electronic ballast during said steady state mode and for driving said LED array based on said received AC supply voltage;
a filament circuit arranged for receiving said AC supply voltage from said electronic ballast and for supporting:
   a filament current circulating back to said electronic ballast for indicating a presence of said lighting device to said electronic ballast, and
   a lamp current to said AC LED driver for driving said LED array for emitting said light during said steady state mode;
a lamp removal simulation circuit arranged for simulating an absence of and/or a failure in said LED lighting device to said electronic ballast by interrupting at least one of said filament current and said lamp current, during said standby mode.

It was the insight of the inventors that the total amount of power during the standby mode is reduced in case the electronic ballast is switched off during that standby mode. Typically, the electronic ballast consumes about 2-8 Watt and the retrofit LED lighting device itself consumes a few hundreds of Milliwatts. As such, the inventors have found that it could be more beneficial to provide for means in the retrofit LED lighting device that ensure that the electronic ballast gets switched off, without switching the mains power supply. That is, the mains power supply is still operating effectively.

In order to accomplish that, a lamp removal simulation circuit is introduced which is arranged to mimic the absence of said retrofit LED lighting device to said electronic ballast by interrupting at least one of said filament current and said lamp current, during said standby mode. That is, the inventors have found that, the electronic ballast will either switch itself off or go into a failure mode, in case at least one of the filament current and the lamp current gets interrupted. The electronic ballast will either sense that no current is drawn by the retrofit LED lighting device and/or will sense that no filament current is flowing, and will use that info to determine that there is no retrofit LED lighting device present and will subsequently switch itself off.

It is noted that, in order to restart the ballast again, the filament circuit should be switched off and switched on again.

In accordance with the present disclosure, the electronic ballast will switch itself off in case an absence and/or a failure in said LED lighting device is simulated. This means that the ballast will either shut down completely, or will go in a failure mode. The ballast can, for example, enter a failure mode in case the filament current(s) keeps flowing, but the lamp current is interrupted. The ballast may then determine that there is something wrong with the retrofit LED lighting device, i.e. the retrofit LED lighting device is not operating correctly, and may switch itself in a failure mode.

One of the aspects of the present disclosure is that the lamp removal simulation circuit is arranged for simulating an absence of, and/or a failure in, said LED lighting device. The real scenario is that the retrofit LED lighting device is actually connected to the electronic ballast but the lamp removal simulation circuit is arranged to operate in such a way that the electronic ballast will perceive as if the retrofit LED lighting device is not present and/or as if the LED lighting device is broken.

Total power consumption is reduced substantially especially in situations wherein the electronic ballast is a High Frequency, HF, ballast, such as Integrated Circuit, IC, controlled ballasts as well as self-oscillating ballasts, or an Electro Magnetic, EM, ballast.

The disclosure is particularly suitable for retrofit LED lighting devices which are retrofit LED tubes for replacing traditional fluorescent tubes.

In the context of the present disclosure, a filament circuit is provided for compatibility, safety, and/or reliability reasons. Such a filament circuit provides an interface between the electronic ballast and the retrofit LED lighting device by emulating the filament of a traditional fluorescent tube lamp.

The retrofit LED lighting device comprises an alternating current, AC, LED driver in order for the LED lighting device to be used as a replacement lighting device for a conventional fluorescent lighting device or a conventional fluorescent tube. The AC LED driver is arranged to receive an AC supply voltage at its input, to convert the AC supply voltage to a DC current, and to provide a DC current, at its output, to the LED array.

Different types of AC LED drivers exist, each of which suitable to be used in the retrofit LED lighting device according to the present disclosure. For example, a half-wave rectification rectifier only allows the positive part of the AC supply voltage to pass while blocking the negative part of the AC supply voltage. This is typically accomplished using a single diode. In another example, a full wave rectification rectifier converts the whole of the AC supply voltage to one of constant polarity at its output. The positive part of the AC supply voltage is allowed to pass, and the negative part of the AC supply voltage is converted to a positive part. This may be accomplished using a bridge rectifier, or by using two diodes in combination with switches.

In accordance with the present disclosure, the lamp current is the current flowing from a first physical connection to the electronic ballast, via the LED lighting device, for example the electronics present in the LED lighting device, to the second physical connection to the electronic ballast. As such, the lamp current is not limited to the current flowing directly through the LED array sec.

In accordance with the present disclosure, the retrofit LED lighting device may be any of a retrofit LED tube or a retrofit LED photoluminescence lamp. A retrofit LED tube is a replacement LED tube for a fluorescent tube which is, for example, a low pressure mercury-vapour gas-discharge lamp that uses fluorescence to produce visible light.

In an embodiment, said lighting device comprises an auxiliary power supply, wherein said auxiliary power supply is arranged to get charged during said steady state mode and wherein said auxiliary power supply is arranged to provide power during said standby mode.

According to the present disclosure, at least one of the filament current and the lamp current is interrupted, by the lamp removal simulation circuit, In order to make sure that the electronic ballast will go to a shutdown mode, or a failure mode. Remaining electronics present in the retrofit LED lighting device will then not be fed by the electronic ballast. In order to make sure that the electronics keep functioning properly, the inventors have found that it would be advantageous to introduce an auxiliary power supply for providing that auxiliary power.

The auxiliary power supply is, for example, a large capacitor, a battery, a super capacitor or anything alike. The auxiliary power supply gets charged during a steady state mode. This means that the electronic ballast is providing power to the LED array for emitting light, but is also providing a charge current to the auxiliary power supply.

Once the standby mode is activated, the power drawn from the electronic ballast is cut off. The electronics will then be powered by the auxiliary power supply itself. This means that the auxiliary power supply will get discharged slowly. As mentioned above, the electronics present in the retrofit LED lighting device draw, typically, a few hundreds of Millliwatts. As such, the capacity of the auxiliary power supply, for example the battery, should be chosen in such a way that the auxiliary power supply is able to provide power to the electronics for at least a predefined amount of time, for example a few minutes, a few hours, a full day, etc.

In a further embodiment, the lamp removal simulation circuit comprises three switches for interrupting at least one of said filament current and said lamp current.

The retrofit LED lighting device comprises, for example, two connecting terminals for connecting to said electronic ballast, wherein each terminal comprises two connecting pins, wherein said lamp removal simulation circuit comprises two filament circuits, wherein each connecting terminal is coupled to one of said two filament circuits for connecting the corresponding two connecting pins thereof to each other, wherein said switches are provided in said two filament circuits.

The advantage of the example described above is that it is an efficient implementation of realizing a lamp removal simulation circuit in accordance with the present disclosure. Introducing three switches enables the retrofit LED lighting device to cut off, i.e. interrupt, the filament currents as well as the lamp current. Detailed aspects of this embodiment are explained with respect to the figures.

In another embodiment, the switches comprise any of a Metal Oxide Semiconductor Field Effect Transistor, MOSFET, a transistor and a relay.

The lamp removal simulation circuit may further comprise a control unit for controlling the switches. The control unit may be any type of hardware such as a microprocessor, a micro controller, a Field Programmable Gate Array, FPGA, or anything alike. The control unit may be empowered via the AC supply voltage, i.e. provided by the electronic ballast, via the same or another AC LED driver, or may be empowered using the auxiliary power supply comprising, for example, a battery, a capacitor or a super capacitor.

In another embodiment, the lighting device further comprises:
a wireless receiver arranged for receiving a wireless command for either putting the retrofit LED lighting device in said standby mode or in said steady state mode.

The wirelessly transmitted command may comprise any of a radio or radio-frequency RF, signal or an infra-red, IR, signal, for example, operated in accordance with a standardized or proprietary signalling protocol. In practice, wireless radio transmission technologies available for use with the invention are, inter alia, ZigBee™, Bluetooth™, WiFi based protocols, or any Mesh type of wireless network.

The wireless receiver may be powered by the auxiliary supply during standby mode and may be powered by the electronic ballast during steady state mode.

In yet another embodiment, the lamp removal simulation circuit is further arranged for measuring an amount of energy in said auxiliary power supply, and for overriding said simulating of said absence of and/or said failure in said LED lighting device to said electronic ballast in case said measured amount of energy falls below a predefined safety threshold.

The advantage of this example that it is ensured that the auxiliary power supply which provides power to the electronics inside the retrofit LED lighting device will not get depleted. In other words, whenever it is detected that the amount of energy left in the auxiliary power supply is below a certain predefined safety threshold, it is decided that the lamp removal simulation circuit is overruled. This does not mean that the LED array will automatically start emitting light. This does mean that the electronic ballast will provide power to the auxiliary power supply inside the retrofit LED lighting device, for recharging said auxiliary power supply.

The lamp removal simulation circuit may start again with simulating the absence of and/or a failure in the LED lighting device towards the electronic ballast, once the auxiliary power supply is charged sufficiently, for example whenever the amount of energy left in the auxiliary power supply exceeds a predetermined storage threshold.

In yet another embodiment, the LED lighting device further comprises a low voltage Direct Current, DC, driver arranged for receiving power from said auxiliary power supply and for driving said LED array.

In a second aspect there is provided a lighting system, comprising: an electronic ballast, and a retrofit LED lighting device according to any of the examples as described above,

wherein said retrofit LED lighting device is connected to said electronic ballast.

Electronic ballasts may regulate the electric flow inside the lamp through electronic circuitry. The electronic ballast, sometimes also referred to as control gear, is typically arranged to limit the current which flows in an electric circuit such that the current is basically kept at a level that prevents the lamp from burning out.

It is noted that the advantages and definitions as disclosed with respect to the embodiments of the first aspect of the invention, being the retrofit LED lighting device, also correspond to the embodiments of the second aspect of the invention, being the lighting system, respectively.

In an embodiment, the electronic ballast is arranged for measuring a current flowing from said electronic ballast to said connected retrofit LED lighting device, and for switching itself off in case no current is measured.

In a third aspect, there is provided a method of operating a retrofit LED lighting device according to any of the examples as provided above, wherein said method comprises the steps of:
receiving, by said AC LED driver, said AC supply voltage from said electronic ballast during said steady state mode, and driving said LED array based on said received AC supply voltage;
switching said steady state mode to said standby mode;
simulating, by said lamp removal simulation circuit, said absence of and/or a failure in said LED lighting device to said electronic ballast by interrupting at least one of said filament current and said lamp current, during said standby mode.

It is noted that the advantages and definitions as disclosed with respect to the embodiments of the first aspect and the second aspect of the invention, being the retrofit LED lighting device and the lighting system, also correspond to the embodiments of the third aspect of the invention, being the method, respectively.

In an embodiment, the method further comprises the steps of:
charging said auxiliary power supply during said steady state mode, and
providing, by said auxiliary power supply, power to said retrofit LED lighting device during said standby mode.

In a further embodiment, the method further comprises the step of:
wirelessly receiving, by said wireless receiver, said wireless command for either putting said retrofit LED lighting device in said standby mode or in said steady state mode.

In another embodiment, the method further comprises the step of:
measuring, by said lamp removal simulation circuit, said amount of energy in said auxiliary power supply, and
overriding, by said lamp removal simulation circuit, said simulating said absence of said LED lighting device to said electronic ballast in case said measured amount of energy falls below said predefined safety threshold.

In yet another aspect, there is provided a computer program product, comprising a readable storage medium, comprising instructions which, when executed on at least one processor, cause the at least one processor to carry out the method according to any of the examples as provided above.

These and other aspects of the invention will be apparent from and elucidated with reference to the embodiment(s) described hereinafter.

### BRIEF DESCRIPTION OF THE DRAWINGS

FIG. 1 shows a schematic block diagram representation of a retrofit Light Emitting Diode, LED, lighting device as available in the prior art.

FIG. 2 shows an exemplary embodiment of a retrofit LED lighting device as available in prior art.

FIG. 3 shows a schematic block diagram representation of a retrofit LED lighting device according to the present disclosure.

FIG. 4 shows an exemplary embodiment of a retrofit LED lighting device according to the present disclosure further showing an example of the position of switches for lamp removal simulation.

FIG. 5 shows an exemplary embodiment of the present disclosure with another possible arrangement of switches for lamp removal simulation.

FIG. 6 shows an exemplary embodiment of the present disclosure with another possible arrangement of switches for lamp removal simulation.

FIG. 7 shows an exemplary embodiment of the present disclosure with another possible arrangement of switches for lamp removal simulation.

FIG. 8 shows a schematic block diagram representation of an embodiment of the disclosure wherein the auxiliary power supply is capable of supplying power to the LED array.

FIG. 9 shows a schematic block diagram representation of an embodiment of the disclosure wherein the driver is capable of operating on both Alternating Current, AC, voltage as well as low level Direct Current, DC, voltage.

### DETAILED DESCRIPTION

A detailed description of the drawings and figures are presented. It is noted that a same reference number in different figures indicates a similar component or a same function of various components.

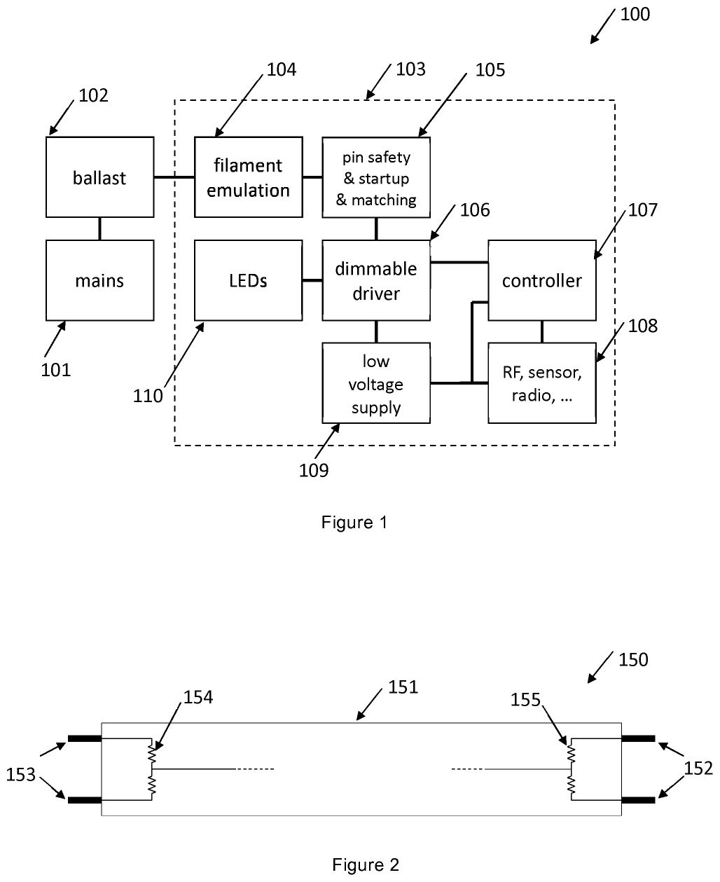

FIG. 1 shows a schematic diagram of a retrofit Light Emitting Diode, LED, lighting device 103 as known in the state of the art. The exemplary system 100 comprises the retrofit LED lighting device 103, which LED lighting device 103 is arranged to receive power from an electronic ballast, 102, which in turn is connected to the AC mains power supply 101. The AC mains power supply can be any power supply available normally to a domestic consumer of electric power at the wall socket or at a suitable power outlet. The electronic ballast 102 is normally designed to be operated with a fluorescent tube and is arranged to provide an output specific to the type of the fluorescent tube that is connected thereto. The ballast can be an IC controlled ballast, or a self-oscillating ballast, high frequency ballast, or any other type of ballast.

Conventionally, and most popularly, electronic ballasts are designed for use with fluorescent tubes. However, it is desired to replace these fluorescent lamps with more energy efficient LED lighting devices. This requires the electronic ballasts to be replaced and additional wiring to be made. This is often undesirable because, often, it is the consumer itself who is responsible for the installation and maintenance of such LED lighting devices. Therefore, it would be advantageous to avoid rewiring and installation of extra components. Incorporating additional circuitry into the LED tube itself provides a method of using the same electronic ballast for LED lighting devices. This process, called retrofitting, is popular and leads to considerable savings in installation and operational costs.

The retrofit LED lighting device 103 is acknowledged as being part of the state of the art. It comprises various components such as the filament emulation 104 to simulate the presence of a filament of a fluorescent tube. The pin safety and startup and matching circuit 110 provides additional safety elements that ensure a robust operation of the retrofit LED lighting device. The LED array 110 outputs light based on the power level received from the AC LED driver 106, i.e. a driver which has an AC input and a DC output. The output of the LED driver is controlled by means of a control signal provided to the LED driver by means of a controller 107.

The controller 107 in turn is arranged to receive its instructions from a sensor or a wireless communication module 108 which is arranged to communicate with external user equipment. Such a user equipment is capable of controlling the various parameters of the retrofit LED lighting device 103 such as brightness, hue, colour, etc. When the control signal is received by the communication module 108, it sends the signal to the controller 107, which adjusts suitable parameters of the LED driver 106 accordingly so that the LED array 110 provides the desired output.

In addition to these components, there is also a low voltage supply 109 present within the retrofit LED lighting device 103 in order to supply the low voltage components within the dimmable drive, controller and wireless communication module (106, 107, 108 respectively).

When the wireless communication module 108 receives an instruction to change the characteristic of the light output from the LED array 110, the system achieves the desired output by varying parameters of the LED driver 106. If the user requires that the light output be zero, this is achieved by decreasing the output of the dimmable driver 106 to zero. The system does not directly affect the mains power supply 101. This means that the electronic ballast 102 continues to receive power and transfers it to the retrofit LED lighting device 103. The inventors have found that this aspect can be improved, i.e. the inventors have acknowledged the power loss in the electronic ballast 102 even when there is no light output from the retrofit LED lighting device 103. The power consumed is usually in the order of 2-5 Watts. This may seem quite small, but over the lifespan of an LED lighting device, typically 40,000-50,000 hours, this energy consumption can be quite large.

FIG. 2 shows a schematic representation of a retrofit LED lighting device 150 which is acknowledged as being part of the state of the art. Reference number 150 indicates a tube for retrofitting conventional fluorescent tubes. The tube has two sets of connecting pins, as indicated with reference numerals 152 and 153, for fitting into an existing light fixture of a fluorescent tube. The tube also has a cover, 151, which also acts as a light diffuser. These retrofit LED lighting devices also have a filament circuits, as indicated with reference numerals 154 and 155. The function of the filament circuits is to simulate, i.e. mimic, the presence of a conventional fluorescent tube. When a filament current that flows through the filament circuit is detected by the electronic ballast, the ballast is able to detect the presence of a lamp and can supply power to the rest of the retrofit LED lighting device.

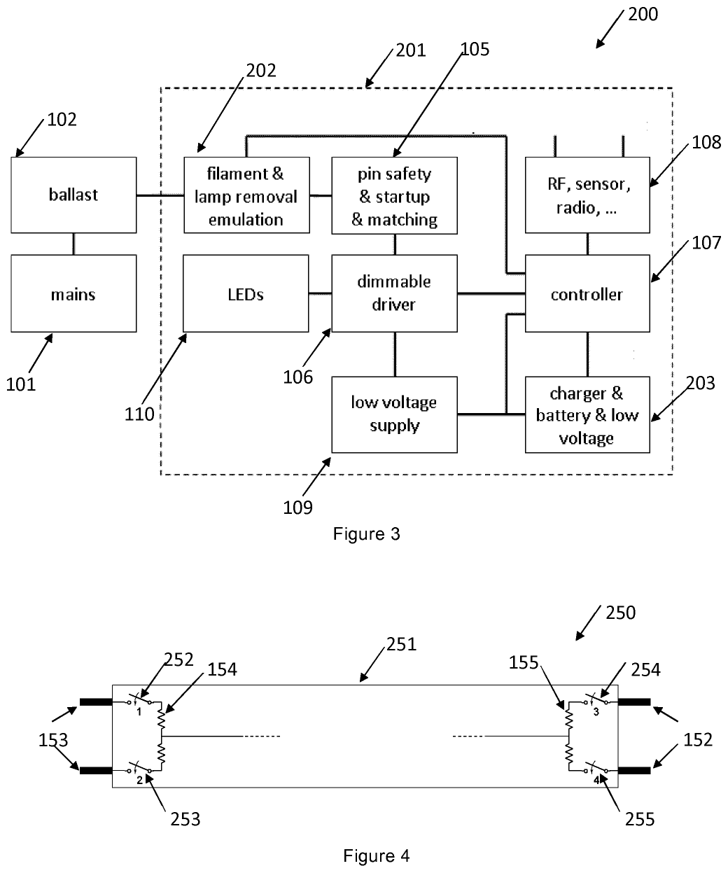

As a solution to the reduction of the energy consumed in the electronic ballast, an embodiment of the invention according to the present disclosure is presented in FIG. 3. Reference numeral 200 indicates a lighting system with reduced energy consumption in the electronic ballast 102. Here, the mains power supply, 101, and the electronic ballast, 102, have not changed as compared to the prior art described in FIG. 1. This means that only the retrofit LED lighting device 201 itself needs to be replaced in order to achieve the desired result of reduced energy consumption.

The retrofit LED lighting device 201 is different from the retrofit LED lighting device, reference numeral 103 of FIG. 1, of the prior art because of the addition of, or changes in, at least two functional blocks, being the lamp removal simulation circuit 202 and charger and battery and low voltage 203. The lamp removal simulation function is integrated into the already existing filament circuit, being indicated with reference numeral 104 of FIG. 1. The function of the lamp removal simulation circuit 202 is to simulate, i.e. mimic, the removal of said retrofit LED lighting device, 201, from the corresponding armature when the desired light output is zero. If such a removal is simulated, then electronic ballast 102 detects that there is no lighting device connected to its output and therefore will almost not draw any power from the mains, 101. The ballast 102 will, in an embodiment, shut itself off. Thus there is no substantial power consumed in the electronic ballast 102. One way in which the lamp removal simulation may be achieved is according to the embodiment shown in FIG. 4.

FIG. 4 shows an exemplary embodiment of the invention according to the present disclosure, wherein the lighting device is a tube, i.e. a retrofit LED tube 251. As is common for tubes, it has two sets of connecting pins, being indicated with reference numerals 152 and 153, on either ends of the tube 251, for enabling connection to the corresponding lighting fixture. The filament circuit, as indicated with the presence of resistors having reference numerals 154 and 155, are connected to each of the two sets of connecting pins. The connecting pins are connected to an electronic ballast (not shown in figure). The presence of a filament current circulating through the filament emulation circuit 154, 155, which is detected by the electronic ballast indicates that a lighting device is connected in the fixture and that, subsequently, the electronic ballast can supply power to the lighting device.

In an exemplary embodiment according to the present invention, a lamp removal simulation circuit consists of a plurality of switches in the filament circuit, as indicated with reference numerals 252, 253, 254, 255. As an example, four switches have been presented, but it may be apparent to the person skilled in the art that the same result may be achieved by fewer or more number of switches. For ease of explanation, the current embodiment is explained with the help of four switches. The switches 252, 253, 254, 255 are, in this particularly case, normally closed switches. It may be possible to implement these switches according to several options. For example they may be implemented using Metal Oxide Semiconductor Field Effect Transistors (MOSFETs) or Transistors or relays. It is desirable that such switches should be controllable, i.e. the position of the switch, whether open or closed, should be controllable by means of a control signal provided by the controller 107.

The use of normally closed switched may be helpful as it ensures that the retrofit LED lighting device will not get into a situation in which it is not able to work anymore. For example, whenever the auxiliary power supply runs out of energy, it can no longer supply energy to open the normally closed switches. The result is that these switches will close. This will cause the ballast to kick in again and to provide power to the retrofit LED lighting device. The power from the ballast will then also recharge the auxiliary power supply.

In an alternative, normally open switches may be deployed. This also has an advantage. The advantage of such switches is that no energy needs to be provided to open the switches during the standby mode. This reduces the total amount of energy consumed during the standby mode even further. There is a risk that the energy in the auxiliary power supply gets depleted. In other words, there is a risk that the remaining energy left in the auxiliary power supply is not sufficient to close the normally closed switches. This is required to let the ballast provide power to the retrofit LED lighting device again. In order to combat that risk, multiple solutions exist. One of the solutions is to measure an amount of energy left in the auxiliary power supply, and to override the simulating of the absence of and/or the failure in the retrofit LED lighting device to the electronic ballast in case the measure amount of energy falls below a predefined safety threshold. Another option is to add one or more physical switches to the housing of the retrofit LED lighting device. The physical switches are incorporated in such a way that they override the simulating of the absence of and/or the failure in the retrofit LED lighting device. As such, a user needs to press the physical switches to make sure that the ballast gets kicked in again.

As an example, if the wireless communication module 108 receives a signal to reduce the light output of the LED array to zero, the control varies the parameters of the LED driver 106 such that the light output is zero. Additionally, the controller also sends a signal to the lamp removal simulation circuit 202 to indicate that a standby mode has to be initiated.

In such a standby mode, control signals switch the switches from a closed position to an open position. When all the four switches 252, 253, 254, 255 are thus opened, no filament current circulates through either of the two filament circuits. Also, there is no flow of current between the two filament circuits themselves. Therefore, the electronic ballast does not detect a filament current and also not a lamp current, therefore a condition of lamp removal is simulated/mimicked. This means that the electronic ballast does not provide an electrical input to the retrofit LED lighting device 201. Thus the power consumed in the electronic ballast 102 is reduced.

However, there is no power supplied to the retrofit LED lighting device 201 whatsoever. This implies that there is no power supplied to the wireless communication means 108 either. This is undesirable as, the signal to turn off the light was communicated wirelessly using an external user equipment and the user expects to turn it back on by the same means, whereas the device is currently unable to do so owing to the lack of power in the wireless communication module 108.

In order to overcome this hurdle, an auxiliary power supply 203 is provided within the retrofit LED lighting device 201. This auxiliary power supply 203 is capable of storing charge during the steady state phase and discharging during the standby mode. During the standby mode, it delivers power to the wireless communication module 108. This implies that the wireless communication module is capable of receiving further instructions from the external user equipment even when the retrofit LED lighting device 201 as a whole does not receive power from the electronic ballast 102.

The auxiliary power supply 203 can be any device that is known to be capable of accumulating charge during a first duration of time and discharging said accumulated charge during a second duration of time. Popular examples include various kinds of batteries, capacitors or supercapacitors. It may also be possible to use any component that the person skilled in the art knows is capable of achieving the same function.

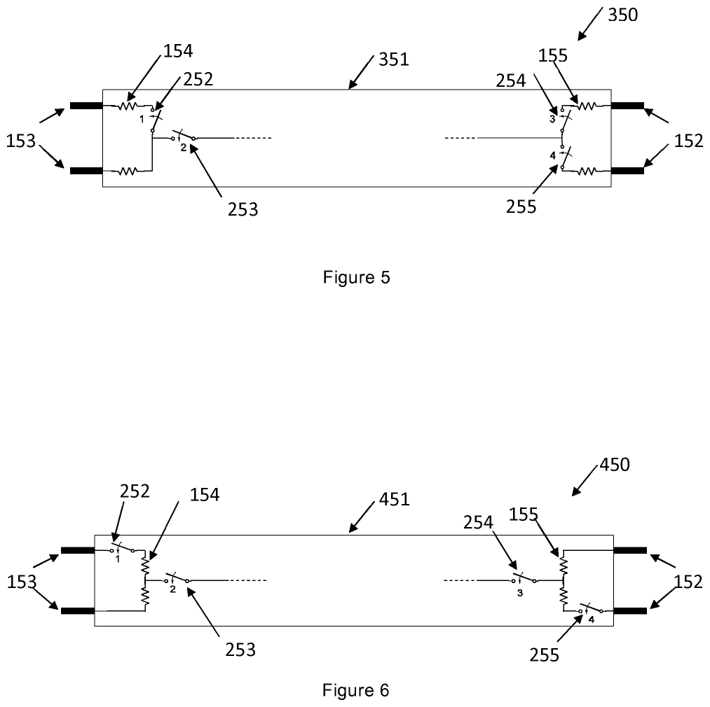

It is to be noted here that, the function of the switches 252, 253, 254, 255 in the lamp removal simulation circuit 202 is to interrupt at least one of the filament current and the lamp current, and the switches may be re-positioned in a manner that allows to do so. A person skilled in the art is able to change the position of the switches in order to achieve the same result. Few of the options available are indicated in FIGS. 5, 6, and 7.

The same result may be obtained by using at least three switches. One to interrupt the filament current in filament circuit 154. The second one to interrupt the filament current in filament circuit 155. The third one to interrupt the lamp current that flows between the two filaments currents 154 and 155. Thereby, it is evident that the lamp removal emulation may be implemented by using at least three switches. More number of switches may also be employed in order to improve reliability and robustness, but it also increases the number of control signals that need to be transmitted by the controller and hence increases the complexity.

It could be the case that lamp removal could be simulated, mimicked, successfully by opening any of the three out of four switches present. As an example opening switches 252, 253 and 254, or switches 252, 254 and 255 could successfully interrupt the two filament currents and also the lamp current, thereby achieving the objective of the invention.

FIG. 5 shows an exemplary embodiment 350, of the present invention with another possible arrangement of switches, 252, 253, 254, 255 for lamp removal simulation. As explained before, any three switches out of the four switches, 252, 253, 254, 255 are switched off in order to achieve the desired result. Preferably switch 253 is switched off in order to interrupt the lamp current and any two switches among 252, 254, 255 are switched off in order to interrupt the filament current. As discussed earlier, it is also possible that all four switches are turned off in order to make the system more robust.

A reset of the ballast can be accomplished by, for example, switching the switches as indicated with reference numerals 252, 254 and 255. This will cause the ballast to start up again, either from a failure mode or from a standby mode or anything alike.

FIG. 6 shows an exemplary embodiment, 450, of the present invention with another possible arrangement of switches 252, 253, 254, 255 for lamp removal simulation. According to this embodiment, switches 253 and 254 are capable of interrupting the lamp current and switches 252, 255 are capable of interrupting the filament current. According to this embodiment, in order to achieve the objective of the invention, switches 252 and 255 are switched off in order to interrupt the filament currents. Additionally any one of, or both of, switches 253 and 254 have to be turned off in order to interrupt the lamp current.

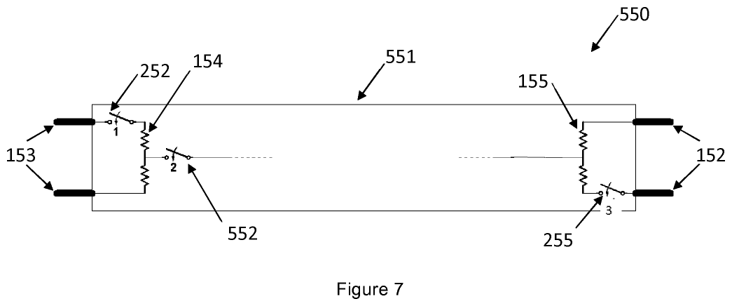

FIG. 7 shows an exemplary embodiment, 550, of the present invention with another possible arrangement of switches, 252, 552, and 255 for lamp removal simulation. According to this embodiment, one of the switches, 552, present in the pin safety circuit is utilised also for lamp removal emulation. The pin safety circuit comprises switches that are present in order to make sure that the retrofit LED lighting device does not create a hazardous situation for a user. Utilising these switches also for lamp removal emulation has the advantage of reducing the number of external switches required to achieve the objective of the present invention.

According to this embodiment, if the retrofit LED lighting device has to enter the standby mode, first switch 552 is turned off followed by switches 252 and 255. In a similar fashion, to go back in to the steady state mode from the standby mode, switches 252 and 255 are turned on first followed by 552.

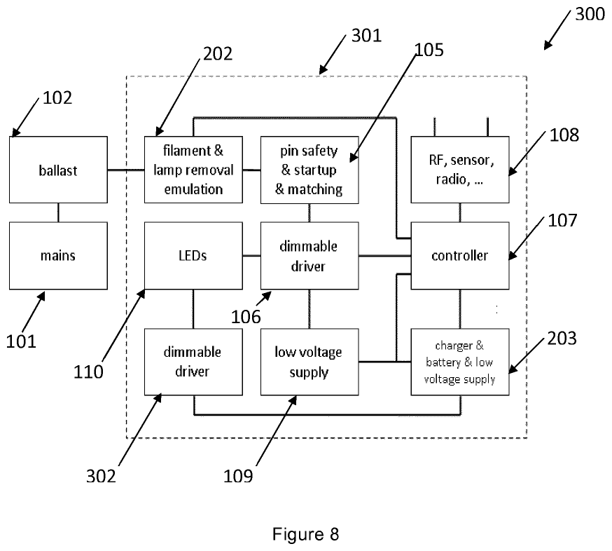

FIG. 8 shows a schematic block diagram representation of an embodiment, 300, of the invention wherein the charge storage device is capable of supplying power to the LED array, 110. As noted earlier, similar reference numerals indicate similar features and functions and these will not be discussed further. Reference number 301 indicates the retrofit LED lighting device. This embodiment further contains a low voltage DC dimmable driver, 302, when compared to the embodiment, 200 in FIG. 3.

It is desirable that the overall power consumed in the lighting arrangement be as low as possible. The purpose of the LED driver is to facilitate the operation of the LED array, 110, by receiving input power from the auxiliary power supply 203. In such an embodiment, for a portion of the steady state mode, the charge storage device, 203, stores charge and the LED array 110, receives input power from the LED driver 106. When it is monitored that the auxiliary power supply 203, has been fully charged, a lamp removal emulation can be performed by the lamp removal simulation module, 202. This implies that the electronic ballast, 102, does not supply power to the LED driver 106.

In such a situation, when the user has not requested the lamp to be turned off, the lamp continues to be powered by the charge storage device, 203. The charge storage device, 203, supplies power to the low voltage DC dimmable driver, 302, which is arranged to receive a low voltage DC voltage and supply power to the LED array, 302. During such an operation, if a request to switch off the lamp is received, the controller can instruct the charge storage device, 203, to stop supplying power to the low voltage DC dimmable driver, 302.

The advantage of such an arrangement is that the electronic ballast does not supply power to the LED lighting device for the entire duration for which the LED lighting device is ON. Thereby, the energy during the time which the ballast, 102, does not supply power to the LED lighting device is saved. As noted earlier, over the lifespan of the LED lighting device, this can result in considerable savings of energy.

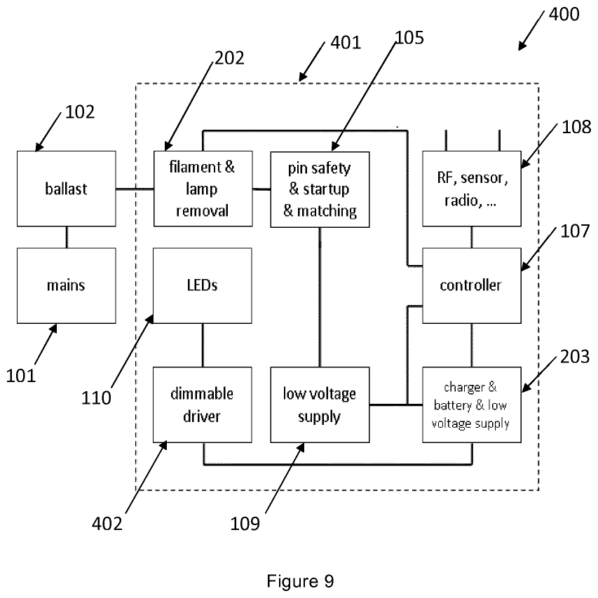

FIG. 9 shows a schematic block diagram representation of an embodiment, 200, of the invention. As noted earlier, similar reference numerals indicate similar features and functions and these will not be discussed further. Reference numeral 401, indicates a retrofit LED lighting device according to the present invention. According to this embodiment, the two drivers, 106 and 302 according to the embodiment 300 in FIG. 8 have been combined in to one single driver, 402. This considerably reduces the space requirement and will have an impact on the total cost of the product as well.

The LED driver, 402 is capable of receiving the charge storage device, 203, i.e. the auxiliary power supply. During standby mode, or when the charge storage device, 203, i.e. auxiliary power supply, is completely charged, the lamp removal simulation means, 202, disconnects the electronic ballast, 102, and the relevant components are powered solely by the charge storage device, 203.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope thereof.

1. A retrofit Light Emitting Diode, LED, lighting device for connection to an electronic ballast, wherein said LED lighting device comprises a steady state mode during which it emits light and a standby mode during which it is not emitting light, said retrofit LED lighting device comprising:
an LED array for emitting light during said steady state mode;
an alternating current, AC, LED driver arranged for receiving an AC supply voltage, from said electronic ballast during said steady state mode and for driving said LED array based on said received AC supply voltage;
a filament circuit arranged for receiving said AC supply voltage from said electronic ballast and for supporting:
a filament current circulating back to said electronic ballast for indicating a presence of said lighting device to said electronic ballast, and
a lamp current to said AC LED driver for driving said LED array for emitting said light during said steady state mode;
a lamp removal simulation circuit arranged for simulating an absence of and/or a failure in said LED lighting device to said electronic ballast by interrupting said filament current, during said standby mode.

2. A retrofit LED lighting device according to claim 1, wherein said lighting device comprises an auxiliary power supply, wherein said auxiliary power supply is arranged to get charged during said steady state mode and wherein said auxiliary power supply is arranged to provide power during said standby mode.

3. A retrofit LED lighting device according to claim 1, wherein said lamp removal simulation circuit comprises three switches for interrupting said filament current and a lamp current.

4. A retrofit LED lighting device according to claim 3, wherein said retrofit LED lighting device comprises two connecting terminals for connecting to said electronic ballast, wherein each terminal comprises two connecting pins, wherein said lamp removal simulation circuit comprises two filament circuit, wherein each connecting terminal is coupled to one of said two filament circuits for connecting the corresponding two connecting pins thereof to each other, wherein said switches are provided in said two filament circuits.

5. A retrofit LED lighting device according to claim 3, wherein said switches comprise any of a Metal Oxide Semiconductor Field Effect Transistor, MOSFET, a transistor and a relay.

6. A retrofit LED lighting device according to claim wherein said lighting device 4044 further comprises:
a wireless receiver arranged for receiving a wireless command for either putting the retrofit LED lighting device in said standby mode or in said steady state mode.

7. A retrofit LED lighting device according to claim 1, wherein said lamp removal simulation circuit is further arranged for measuring an amount of energy in said auxiliary power supply, and for overriding said simulating said absence of said LED lighting device to said electronic ballast in case said measured amount of energy falls below a predefined safety threshold.

8. A retrofit LED lighting device according to claim 1, wherein said LED lighting device further comprises a low voltage Direct Current, DC, driver arranged for receiving power from said auxiliary power supply and for driving said LED array.

9. A lighting system, comprising:
an electronic ballast, and
a retrofit LED lighting device according to claim 1,
wherein said retrofit LED lighting device is connected to said electronic ballast.

10. A lighting system according to claim 9, wherein said electronic ballast is arranged for measuring a current flowing from said electronic ballast to said connected retrofit LED lighting device, and for switching itself off in case no current is measured.

11. A method of operating a retrofit LED lighting device according to claim 1, wherein said method comprises the steps of:
receiving, by said AC LED driver, said AC supply voltage from said electronic ballast during said steady state mode, and driving said LED array based on said received AC supply voltage;
switching said steady state mode to said standby mode;
simulating, by said lamp removal simulation circuit, said absence of and/or a failure in said LED lighting device to said electronic ballast by interrupting said filament current, during said standby mode.

12. A method of operating a retrofit LED lighting device according to claim 11, wherein said method further comprises the steps of:
charging said auxiliary power supply during said steady state mode, and
providing, by said auxiliary power supply, power to said retrofit LED lighting device during said standby mode.

13. A method of operating a retrofit LED lighting device according to claim 11, wherein said method further comprises the step of:
wirelessly receiving, by said wireless receiver, said wireless command for either putting said retrofit LED lighting device in said standby mode or in said steady state mode.

14. A method of operating a retrofit LED lighting device according to claim 11, wherein said method further comprises the step of:
measuring, by said lamp removal simulation circuit, said amount of energy in said auxiliary power supply, and
overriding, by said lamp removal simulation circuit, said simulating said absence of said LED lighting device to said electronic ballast in case said measured amount of energy falls below said predefined safety threshold.

15. Computer program product, comprising a readable storage medium, comprising instructions which, when executed on at least one processor, cause the at least one processor to carry out the method according to claim 11.
